(19) United States
(12) Patent Application Publication
(10) Pub. No.: US 2015/0215277 A1
(43) Pub. Date: Jul. 30, 2015

(54) NETWORK ADDRESS TRANSLATION APPARATUS WITH COOKIE PROXY FUNCTION AND METHOD FOR NAT SUPPORTING COOKIE PROXY FUNCTION

(71) Applicant: ELECTRONICS AND TELECOMMUNICATIONS RESEARCH INSTITUTE, Daejeon (KR)

(72) Inventor: Hwan Jo HEO, Daejeon (KR)

(21) Appl. No.: 14/602,590

(22) Filed: Jan. 22, 2015

(30) Foreign Application Priority Data
Jan. 28, 2014 (KR) 10-2014-0010297
Apr. 9, 2014 (KR) 10-2014-0042277

(51) Int. Cl. H04L 29/12; H04L 29/08; H04L 29/06

(52) U.S. Cl. CPC H04L 61/2567; H04L 67/42; H04L 67/146

(57) ABSTRACT

Provided is a network address translation (NAT) apparatus including: a NAT unit translating an address so as for a client and a server to communicate with each other through an outside network by referring to a NAT table that manages an inside IP address and an outside IP address mapped to the inside IP address; and a cookie proxy unit providing a cookie to the client by referring to a connection cookie table that manages a cookie corresponding to the outside IP address when there is a cookie request from the client.

### CROSS-REFERENCE TO RELATED APPLICATIONS

This application claims priority to and the benefit of Korean Patent Application No 10-2014-0010297 filed in the Korean Intellectual Property Office on Jan. 28, 2014, and Korean Patent Application No. 10-2014-0042277 filed in the Korean Intellectual Property Office on Apr. 9, 2014, the entire contents of which are incorporated herein by reference.

### TECHNICAL FIELD

The present invention relates to a network address translation apparatus and a network address translation method, and more particularly, to a network address translation apparatus and a network address translation method that simultaneously perform a cookie proxy function.

### BACKGROUND ART

The network bandwidth, packet loss rate, and network delay are dominant factors that affect the overall network performance experienced by users; the network performance—the throughput or completion time of the data transfer—largely depends on the network delay if the amount of data transferred is small while the network bandwidth comes into play as the transferred data scale. The network protocols such as HTTP (HyperText Transfer Protocol) 2.0 for the World Wide Web, TFO (TCP Fast Open) that leverages connections cookies to reduce the TCP (Transmission Control Protocol) connection latency, and QUIC (Quick UDP Internet Connections) which work upon UDP (User Datagram Protocol) to facilitate low-latency connections are introduced to alleviate the performance degradation due to network delay.

Application layer protocols—protocols that framework messaging between the server and client—such as HTTP operate on top of the transport layer in which TCP dominates. TCP performs the end-to-end connection establishment by a three-way handshake that takes a single RU (Round Trip Time) to complete. TFO and QUIC implement the piggybacking of the initial data request message to the connection request message to save such connection latency.

However, the piggybacking makes the server skip the verification process—the process of sending back the connection reply to the client and receives an acknowledgement that verifies the address of the other end is valid, i.e., not spoofed—and process the request without such verification communication; the server becomes more vulnerable to the attacks such as DDoS (Distributed Denial of Service.)

The protocols such as TFO and QUIC propose a client authentication method using connection cookies; the server issues a connection cookie—a cookie that can be submitted by the client to the server as a certificate that verifies the previously successfully established connection—to the client at an initial connection establishment.

However, connection cookies are not compatible to the network address translation (NAT). In general, a single connection cookie is generated for each unique client IP address (for each remote IP) but many NAT implementations do not provide one-to-one mapping between the NAT inside and NAT outside IPs.

For example, clients with different NAT inside IPs can share the same NAT outside IP for which only one client that made the initial connection establishment receives the connection cookie; other clients with the same NAT outside IP do not know the connection cookie and reissuing for the same NAT outside IP will invalidate the previously issued cookie.

### SUMMARY OF THE INVENTION

The present invention has been made in an effort to provide a NAT apparatus and a NAT method for using a connection cookie even under a NAT environment to minimize a connection delay time while resolving a problem of IP address shortage.

The present invention has also been made in an effort to provide a NAT apparatus and a NAT method that efficiently subrogates transferring the connection cookie through a connection cookie proxy in order to use the connection cookie under the NAT environment.

The technical objects of the present invention are not limited to the aforementioned technical objects, and other objects, which are not mentioned above, will be apparent to those skilled in the art from the following description.

An embodiment of the present invention provides a network address translation (NAT) apparatus including: a NAT unit translating an address so as for a client and a server to communicate with each other through an outside network by referring to a NAT table that manages an inside IP address and an outside IF address mapped to the inside IP address; and a cookie proxy unit providing a cookie to the client by referring to a connection cookie table that manages a cookie corresponding to the outside IP address when there is a cookie request from the client to perform a cookie proxy function even under a NAT environment.

The cookie proxy unit may include a packet determining unit determining whether a received packet corresponds to a cookie request packet or a cookie response packet; and a cookie deducing unit deducing the cookie from the connection cookie table by searching the outside IP address of the received packet from the NAT table when the received packet is the cookie request packet. The NAT apparatus may further include a cookie responding unit generating a cookie response based on the deduced cookie.

The cookie deducing unit may transfer the received packet to the NAT unit when the received packet is the cookie request packet, but an entry corresponding to the outside IP address does not exist in the connection cookie table. According to the embodiment, the NAT unit may request the cookie to the server by performing network address translation (NAT) for the received packet corresponding to the cookie request packet.

The cookie proxy unit may further include a cookie managing unit updating the connection cookie table or generating a new entry based on cookie information included in the received packet when the received packet is the cookie response packet.

The cookie determining unit may provide the received packet to the NAT unit, which may perform a network address translation operation when the received packet does not correspond to at least one of the cookie request packet and the cookie response packet.

The NAT apparatus may further include a client terminal physically connected with a network at the client side and a server terminal physically connected with a network at the server side. The packet determining unit may determine only whether the received packet is the cookie request packet when the received packet is received from the client terminal and determine only whether the received packet is the cookie response packet when the received packet is received from the server.

The connection cookie table may include information on a pointer in the NAT table corresponding to the outside IP address of the cookie or an outside port corresponding to the outside IP address.

Another embodiment of the present invention provides a network address translation (NAT) method supporting a cookie proxy function in a NAT apparatus including a connection cookie table managing a cookie corresponding to an outside IP address, the method including: determining whether a received packet corresponds to a cookie request packet or a cookie response packet; and providing a cookie response by deducing the cookie from the connection cookie table when the received packet corresponds to the cookie request packet.

The providing of the cookie response may include searching the outside IP address from a NAT table based on an inside IP address included in the received packet, deducing the cookie from the connection cookie table based on the searched outside IP address, and generating the deduced cookie as the cookie response.

The NAT method may further include performing network address translation (NAT) for the received packet when there is no entry of the outside IP address of the received packet in the connection cookie table.

The NAT method may further include managing the connection cookie table based on cookie information included in the received packet when the received packet is the cookie response packet.

The NAT method may further include performing a network address translation (NAT) operation for the received packet when the received packet does not correspond to at least one of the cookie request packet and the cookie response packet.

According to embodiments of the present invention, since a connection cookie can be used even under a NAT environment to protect an inside network from the outside while resolving a problem of IP address insufficiency, a connection delay time can be reduced while maintaining high security.

The embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram for conceptually describing a communication system including a network address translation apparatus with a cookie proxy function according to an embodiment of the present invention.

FIG. 2 is a diagram illustrating the NAT apparatus with the cookie proxy function according to the embodiment of the present invention.

FIG. 3 is a diagram illustrating NAT tables table_N.

FIG. 4 is a diagram illustrating connection cookie tables table_C.

FIG. 5 is a block diagram illustrating a cookie proxy unit according to the embodiment of the present invention.

FIG. 6 is a flowchart for describing a NAT method for supporting a cookie proxy function according to another embodiment of the present invention.

FIGS. 7 and 8 are flowcharts for exemplarily describing a connection cookie proxy operation according to the embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings. Like reference numerals refer to like elements in the drawings and a duplicated description of like elements will be skipped.

Regarding the embodiments of the present invention disclosed in the specification, specific structural or functional descriptions are exemplified to describe the embodiment of the present invention and the embodiments of the present invention may be carried out in various forms and it should not be analyzed that the present invention is limited to the embodiments described in the specification.

Terms such as first, second, A, B, (a), (b), and the like may be used in describing the components of the embodiments of the present invention. The terms are only used to distinguish a constituent element from another constituent element, but nature or an order of the constituent element is not limited by the terms.

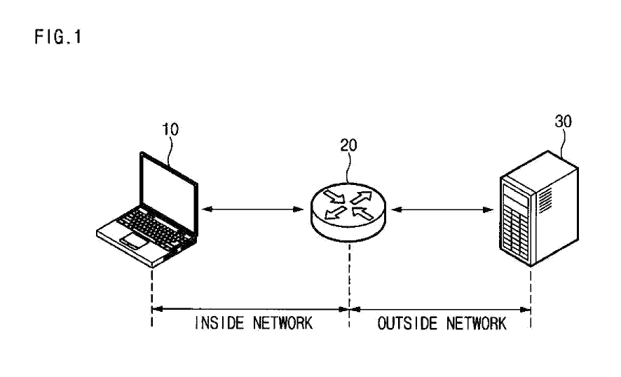

FIG. 1 is a diagram for conceptually describing a communication system including a network address translation apparatus with a cookie proxy function according to an embodiment of the present invention.

Referring to FIG. 1, the NAT apparatus 20 performs network address translation between an inside network and an outside network when a client 10 and a server 30 communicate with each other. In the NAT, one outside IP address does not correspond to a client having one inside IP and one outside IP address corresponds to inside IPs of multiple clients to be used for resolving a problem of IP address shortage or hide existence of the client from the outside network.

In the specification, the outside IP address may indicate an address used in a public, global, or outside network and the inside IP address may indicate an address used in a private or local network.

The NAT apparatus 20 includes a NAT table that manages the inside IP address, and an outside IP address corresponding to the inside IP address. The NAT apparatus 20 translates the inside IP address of a packet received from the client 10 into the outside IP address and transmits the outside IP address to the server 30.

The NAT apparatus 20 translates the outside IP address of the packet received from the server 30 into the inside IP address and provides the inside IP address to the client 10.

However, there is a problem that a connection cookie method in which one cookie is allocated to one IP may not be applied under an environment of the NAT apparatus 20 as described above, and as a result, a new cookie may be required to be allocated whenever the NAT apparatus 20 is connected with the client 10.

The NAT apparatus 20 according to the present invention has the cookie proxy function to deduce a cookie from an inside connection cookie table only by the inside IP address of the client 10 and provide the deduced cookie to the client 10. As a result, since the connection cookie may be used even under the NAT environment, security may be improved and a connection delay time may also be reduced.

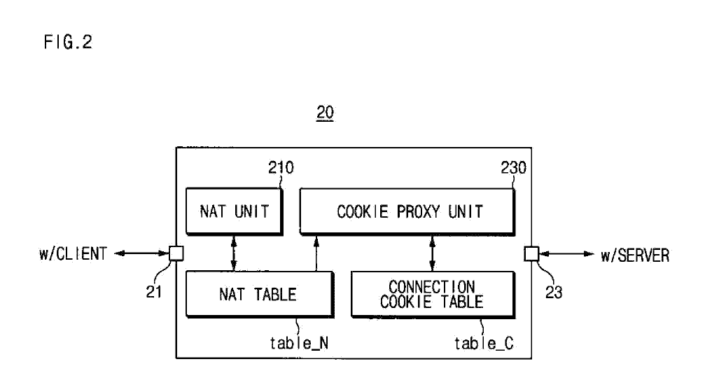

FIG. 2 is a diagram illustrating the NAT apparatus with the cookie proxy function according to the embodiment of the present invention.

Referring to FIG. 2, the NAT apparatus 20 may include a NAT unit 210 and a cookie proxy unit 230. Further, the NAT apparatus 20 may manage a NAT table table_N and a connection cookie table table_C. In FIG. 2, a block diagram is expressed in order to conceptually illustrate that the NAT unit 210 and the cookie proxy unit 230 transmit and receive data to and from the NAT table table_N and the connection cookie table table_C, but the NAT table table_N and the connection cookie table table_C may be managed in different database formats or stored in the NAT unit 210 or the cookie proxy unit 230.

The NAT unit 210 translates the inside IP address of the received packet into the outside IP address by referring to the NAT table table_N or translates the outside IP address of the received packet into the inside IP address to enable the communication between the inside network and the outside network. In the specification, it is described that such an operation of the NAT unit 210 is to perform the network address translation operation.

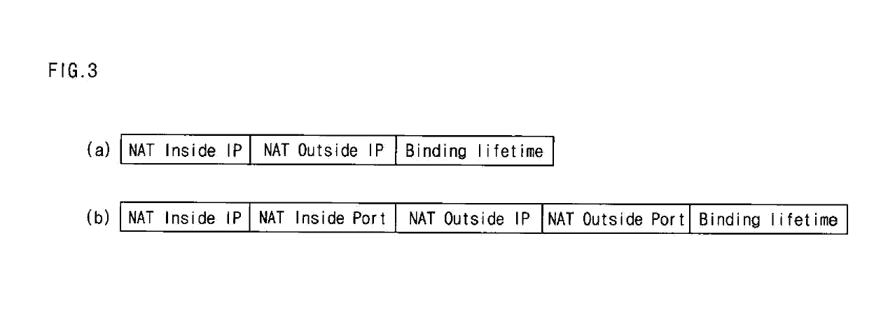

FIG. 3 is a diagram illustrating NAT tables table_N.

Referring to FIG. 3, the inside IP address (NAT inside IP) and the outside IP address (NAT outside IP) are mapped to each other to be, managed in table (a) and may include binding lifetime information of the mapping therebetween. Respective addresses of the table called ‘entry’.

The NAT table table_N may additionally include port information in addition to the IP address like table (b).

The cookie proxy unit 230 determines whether the received packet is a cookie request packet or a cookie response packet, and deduces the outside IP address corresponding to the inside IP address included in the packet from the NAT table table_N when the received packet is the cookie request packet and searches a cookie of the connection cookie table table_C corresponding to the resulting outside IP address.

The connection cookie table table_C may include cookie information corresponding to the outside IP address and a remote IP address (that is, the IP address of the server).

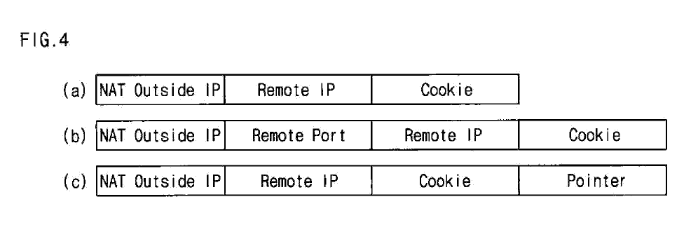

FIG. 4 is a diagram illustrating connection cookie tables table_C.

Referring to FIG. 4, the connection cookie table table_C includes, as required components, the outside IP address (NAT outside IP), the remote IP address (remote IP) (the remote IP as a state IP connected with the outside IP is used as substantially the same concept as the server IP in the specification. However, the remote IP address may correspond to an IP of another client other than the server IP depending on a target which communicates with the client), and the cookie.

The (a) table shows an example of the basic connection cookie table table_C. According to the embodiment, the connection cookie table table_C may be different depending on a used protocol. For example, when the NAT apparatus 20 supports a protocol in which the cookie is generated above a transport layer, a remote port item may be additionally included as shown in the (b) table. Further, according to the embodiment, the connection cookie table table_C includes the binding lifetime information of the cookie or makes the inside IP address (NAT inside IP) or the inside port (NAT inside port) information included in the NAT table table_N be included in the connection cookie table table_C to shorten a time required for searching the NAT table table_N.

Referring to table (c), a pointer may be provided for each entry of the connection cookie table table_C. When the pointer is provided like the table (c), a time required for the cookie proxy unit 230 to search another information corresponding to the outside IP address (NAT outside IP) in the NAT table may be reduced. As described above, the connection cookie table table_C may be variously modified as necessary.

When the cookie for the cookie request packet exists, the cookie proxy unit 230 processes the corresponding cookie to a cookie response and provides the cookie response to the client (10 of FIG. 1), For example, the outside IP address (NAT outside IP) corresponding to the inside IP address (NAT inside IP) included in the cookie request packet is searched from the NAT table table_N and the cookie for the corresponding outside IP address (NAT outside IP) is deduced. The cookie proxy unit 230 generates the cookie response based on the deduced cookie and provides the generated cookie response to the client 10. The cookie response may be provided by setting a source IP address and a port number of the packet according to a regulation as necessary. A format of the packet generated as the cookie response may be different according to the protocol supported by the NAT apparatus 20.

For example, the cookie proxy unit 230 may should be able to generate a predetermined SYN number in the case of TFO and allow the server to receive an SYN number for actual data exchange by additionally transferring a TCP FIN or TCP RST packet to the client 10 that requests the cookie.

When the cookie does not exist in the connection cookie table table_C, the cookie proxy unit 230 performs the NAT operation as it is by transmitting the cookie request packet to the NAT unit 210 to request the cookie to the server 300.

The cookie proxy unit 230 provides the received packet to the NAT unit 210, which performs the NAT operation when the received packet is the cookie request packet or the cookie response packet. That is, the cookie proxy unit 230 operates similarly to the general NAT apparatus 20 when the received packet is not the cookie request packet or the cookie response packet.

When the received packet is the cookie response packet, the cookie proxy unit 230 may update the connection cookie table table_C or generate a new entry based on the cookie information included in the cookie response.

For example, the cookie response packet may be provided from the server 30, and according to a result of searching the cookie corresponding to the outside IP address (NAT outside IP) in the connection cookie table table_C, when a received cookie is different from the current cookie, the connection cookie table tableS is updated. Further, when the cookie information corresponding to the outside IP address (NAT outside IP) included in the cookie response from the server 30 does not exist in the connection cookie table tableS, the new entry is generated to be later used.

The cookie proxy unit 230 may manage the cookie by updating the connection cookie table table_C, and the like and thereafter, provide the cookie to the client 10 by performing the NAT operation in respects to the cookie response.

According to the embodiment, the NAT apparatus 20 may include a client terminal 21 and a server terminal 23. The client terminal 21 is a terminal that is physically and electrically connected with a client-side network and the server terminal 23 is a terminal that is physically and electrically connected with a server-side network. The NAT apparatus 20 receives the packet from the client 10 through the client terminal 21 and receives the packet from the server 30 through the server terminal 23.

Since the cookie proxy unit 230 may find that the packet received through the client terminal 21 does not at least correspond to the cookie response packet, the cookie proxy unit 230 determines only whether the packet received through the client terminal 21 is the cookie request packet to provide the cookie to the client 10 by searching the connection cookie table table_C or transmit the cookie request to the server 30 by performing the NAT operation.

The cookie proxy unit 230 may find that the packet received through the server terminal 23 does not at least correspond to the cookie request packet. Accordingly, the cookie proxy unit 230 determines only whether the packet received through the server terminal 23 is the cookie response packet to manage the connection cookie table table_C and provide the cookie response to the client 10 or provide the received packet to the client 10 by performing the NAT operation.

However, according to the embodiment, the cookie proxy unit 230 may determine whether the received packet corresponds to the cookie request packet or the cookie response packet based on only the information on the received packet regardless of a physical position where the packet is received.

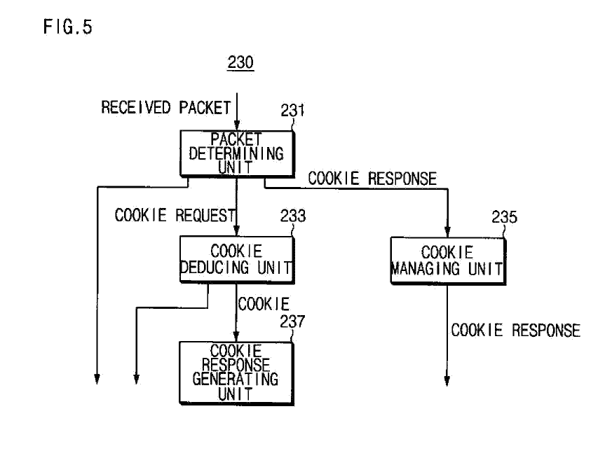

FIG. 5 is a block diagram illustrating a cookie proxy unit according to the embodiment of the present invention.

Referring to FIG. 5, the cookie proxy unit 230 may include a packet determining unit 231, a cookie deducing unit 233, and a cookie managing unit 235.

The packet determining unit 231 determines whether the received packet corresponds to the cookie request packet or the cookie response packet. The packet determining unit 231 may determine whether the received packet corresponds to the cookie request packet or the cookie response packet based on the information (e.g., field configuration or field information) on the received packet or determine whether the received packet corresponds to the cookie request packet or the cookie response packet from the physical terminal by which the packet is received.

In the specification, it is illustrated and described in the drawings that the packet determining unit 231 is included in the cookie proxy unit 230 for convenience of description, but the packet determining unit 231 may be included in the NAT unit 210 or implemented as a separate component in the NAT, apparatus 20.

The packet determining unit 231 provides the received packet to the NAT unit 210, which performs the NAT operation when the received packet does not correspond to at least one of the cookie request packet and the cookie response packet. That is, in this case, only the NAT operation is performed in respects to the received packet to allow the inside network and the outside network to communicate with each other.

The packet determining unit 231 transfers the cookie request packet to the cookie deducing unit 233 when the received packet corresponds to the cookie request packet and transfers the cookie response packet to the cookie managing unit 235 when the received packet corresponds to the cookie response packet.

The cookie deducing unit 233 deduces the outside IP address (NAT outside IP) by searching the NAT table table_N based on the inside IP address (NAT inside IP) included in the cookie request packet. The cookie deducing unit 233 deduces the cookie for the cookie request packet by searching the connection cookie table tableS based on the deduced outside IP address (NAT outside IP).

When the cookie for the client 10 that transmits the cookie request packet exists in the connection cookie table table_C, the cookie is immediately provided to the client 10 without requesting the cookie to the server 30. Accordingly, when the NAT apparatus 20 according to the present invention is provided, the connection cookie may be used without an additional connection process such as 3-way handshake.

However, the cookie deducing unit 233 searches the cookie for the client 10 that transmits the cookie request packet from the connection cookie table table_C, but when the cookie for the outside IP address (NAT outside IP) of the client does not exist, the NAT operation is performed in respects to the cookie request packet to request the cookie to the server 30.

The cookie proxy unit 230 according to the embodiment of the present invention may further include a cookie response generating unit 237. The cookie response generating unit 237 may generate the cookie response as a standard corresponding to a standard supported by the NAT apparatus 20 based on the cookie information received from the cookie deducing unit 233 and provide the generated cookie response to the client 10.

The cookie managing unit 235 updates the connection cookie table table_C when the cookie in the connection cookie table table_C should be updated in respects to the cookie response received from the packet determining unit 231 and manages the cookie by generating the new entry when the cookie for the outside IP address (NAT outside IP) of the received cookie response packet does not exist in the connection cookie table table_C.

The cookie managing unit 235 provides the cookie response to the NAT unit 210 to provide the cookie response to the client 10.

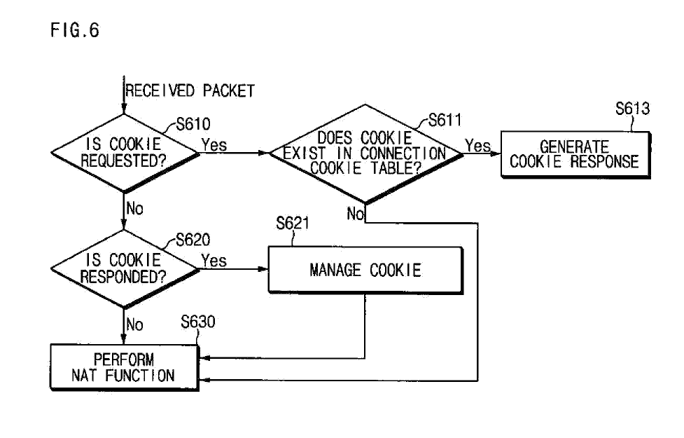

FIG. 6 is a flowchart for describing a NAT method for supporting a cookie proxy, function according to another embodiment of the present invention. Referring to FIG. 6, a packet determining unit 231 determines whether a received packet corresponds to a cookie request packet (step S610). When the received packet corresponds to the cookie request packet (step S610, Yes), the packet determining unit 231 provides the received packet to a cookie deducing unit 233 to determine whether a cookie for the corresponding cookie request exists by referring to a connection cookie table table_C (step S611).

When the cookie for the cookie request packet, exists in the connection cookie table table_C (step S611, Yes), the cookie deducing unit 233 provides cookie information to a cookie response generating unit 237 to generate a cookie response (step S613). The generated cookie response is provided to a client 10.

Although the cookie for the cookie request packet is searched, when the cookie for the cookie request packet does not exist in the connection cookie table table_C (step S611, No), the cookie deducing unit 233 provides the received packet to a NAT unit 210, which performs a NAT operation (step S630). The cookie request packet subjected to the NAT operation may be transmitted to a server 30 through an outside network.

When the received packet is not the cookie request packet (step S610, No), the packet determining unit 231 may determine whether the received packet corresponds to a cookie response packet (step S620). Although it is illustrated in FIG. 6 that whether the received packet is the cookie request packet is determined earlier than whether the received packet is the cookie response packet, the present invention is not limited to the illustrated sequence and the packet determining unit 231 may simultaneously determine whether the received packet corresponds to the cookie request packet and whether the received packet corresponds to the cookie response packet.

As described with reference to FIG. 2 according to the embodiment, when the packet determining unit 231 determines a feature of the received packet based on a physical reception terminal by which the packet is received, one step of the operation (step S610) of determining whether the received packet is the cookie request packet and the operation (step S620) of determining whether the received packet is the cookie response packet may be omitted.

In detail, when the received packet is received from a server terminal 23 which communicates with a server side, since the received packet is not at least the cookie request packet, steps S610, S611, and S613 may be omitted. The packet determining unit 231 determines only whether the received packet corresponds to the cookie request packet (step S620).

On the contrary, when the received packet is received from a client terminal 21 which communicates with a client side, the received packet will not at least be the cookie response packet. Accordingly, the process (step S620) of determining whether the received packet is the cookie response packet and a process (step S621) of managing a cookie may be omitted.

When it is determined that the received packet is the cookie response packet (step S620, Yes), the packet determining unit 231 provides the received packet to a packet managing unit 235.

The cookie managing unit 235 searches an outside IP address (NAT outside IP) included in the received packet, that is, the received cookie response packet in the connection cookie table table_C. In the connection cookie table table_C, when a cookie mapped to the outside IP address (NAT outside IP) is not the same as the received cookie response packet, the cookie managing unit 235 updates the connection cookie table table_C similarly to information on the received cookie response packet. In addition, when the outside IP address (NAT outside IP) included in the received cookie response packet is not searched in the connection cookie table table_C, new entries for the corresponding outside IP address (NAT outside IP) and a remote IP (remote IP) are generated to manage the cookie (step S621).

When the cookie management is completed, the cookie managing unit 235 provides the received packet to the NAT unit 210 to perform the NAT operation and provide the cookie response to the client 10 (step S530).

When the received packet is not the cookie request packet (step S610, No) and not the cookie response packet (step S620, No), since an operation associated with the cookie need not be performed in respects to the received packet, the packet determining unit 231 provides the received packet to the NAT unit 210, which performs the NAT operation (step S630).

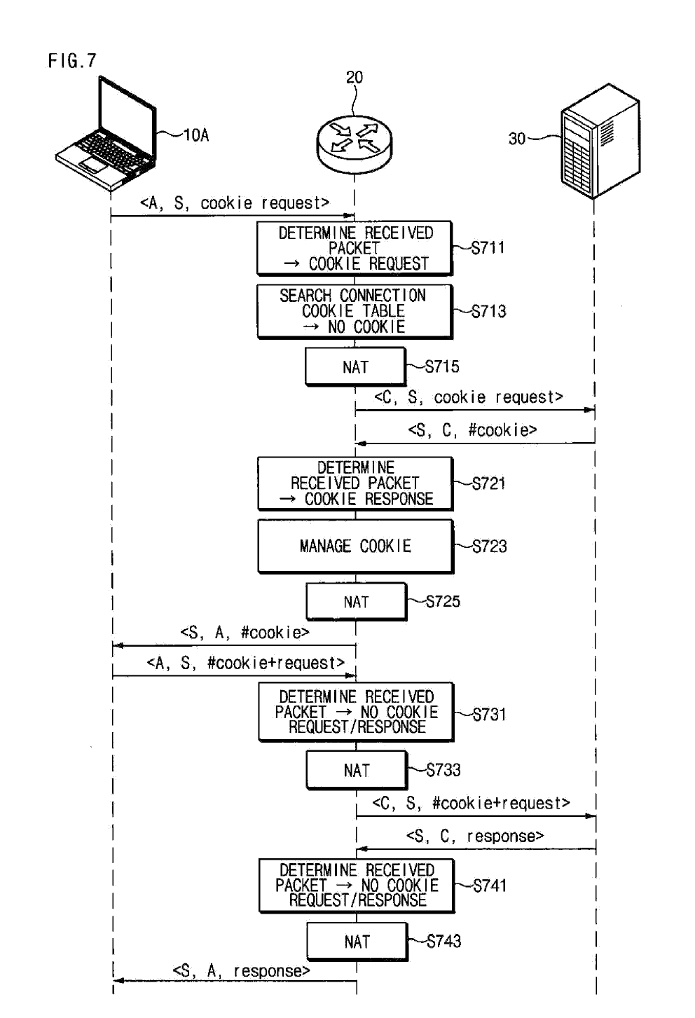

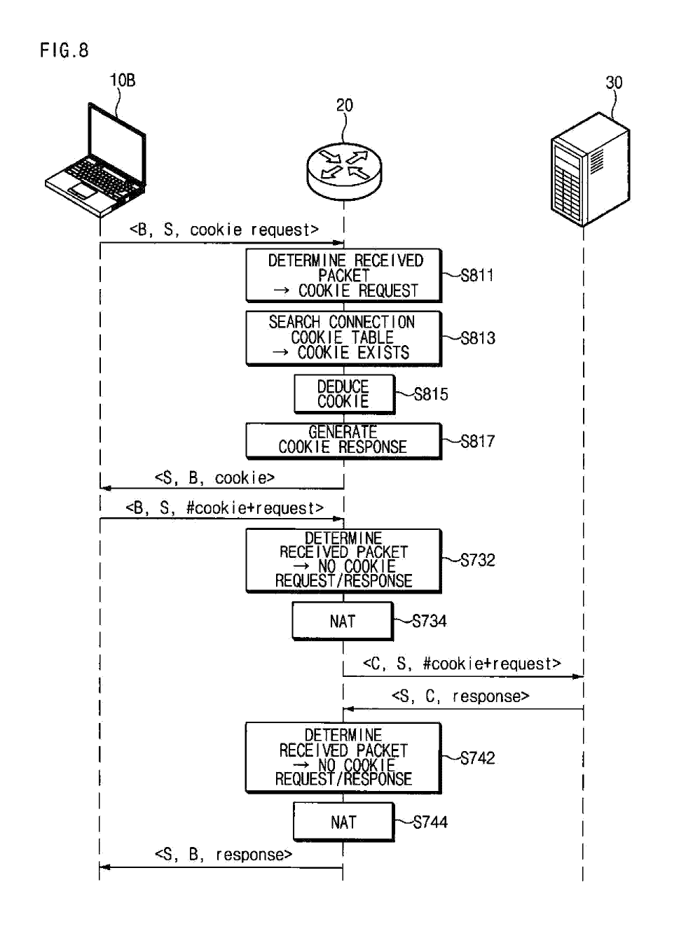

A connection cookie proxy operation according to the present invention will be described with reference to the flowcharts of FIGS. 7 and 8 for exemplary description.

The NAT apparatus 20 that refers to a NAT table table_N including entries shown in Table 1 may operate as illustrated in FIG. 7.

TABLE 1

| NAT Inside | NAT Inside | NAT Outside | NAT Outside | Binding |
|---|---|---|---|---|
| IP | Port | IP | Port | Lifetime |
| A | P | C | Q | 120 s |

A process will be described, in which a client 10A having the inside IP address (NAT inside IP) which is ‘A’ (in addition, an inside port address is ‘P’) makes connection with the server 30—the remote IP address of the server is ‘S’—positioned in the outside network of the NAT apparatus 20 and thereafter, the client 10A communicates with the server 30.

The outside IP address (NAT outside IP) for the client 10A is ‘C’ (in addition, an outside port address is ‘Q’).

The client 10A having the outside IP address (NAT outside IP) which is ‘C’ first sends the cookie request packet in order to make connections with the server 30.

In FIGS. 7 and 8, the packets are indicated as <X, Y, Z>. X represents a source IP address, Y represents a destination IP address, and Z represents a type of a message.

The client 10A transmits a packet of <A, S, cookie request> to the NAT apparatus 20. That is, a packet of a cookie request is sent from the source IP address ‘A’ up to the destination IP address of'S′.

The packet determining unit 231 of the NAT apparatus 20 determines that the received packet is the cookie request packet (step S711). In addition, the cookie deducing unit 233 searches the connection cookie table table_C based on the information on the provided received packet. Although the connection cookie table table_C is searched, the cookie corresponding to ‘C’ as the outside IP address (NAT outside IP) is not searched (step S713), the inside IP address (NAT inside IP) ‘A’, is translated into the outside IP address (NAT outside IP), ‘C’ through the NAT unit 210 (step S715), and as a result, the packet of <C, S, cookie request> is transmitted to the server 30.

The server 30 allocates a cookie (#cookie) to the outside IP address (NAT outside IP) of ‘C’ to provide a cookie response packet of <S, C, #cookie> to the NAT apparatus 20.

The packet determining unit 231 included in the NAT apparatus 20 determines that the packet received from the server 30 is the cookie response packet (step S721). Since the entry of the connection cookie table table_C for the outside IP address (NAT outside IP) ‘C’, does not exist in the previous step (step S713), the cookie managing unit 235 generates the corresponding entry to manage the cookie of the connection cookie table table_C (step S723).

That is, the cookie managing unit 235 generates entries shown in Table 2 in the connection cookie table table_C.

TABLE 2

| NAT Outside IP | Remote IP | Cookie |
|---|---|---|
| C | S | #cookie |

The cookie managing unit 235 provides the received packet to the NAT unit 210 to translate the outside IP address (NAT outside IP) ‘C’, into the inside IP address (NAT inside IP) ‘A’ (step S725), and provide the packet of <S, A, #cookie> to the client 10A.

The aforementioned process is called a cookie transaction. After the cookie for the outside IP address (NAT outside IP) is allocated through the cookie transaction, the client 10A that receives the cookie may use the cookie without an additional connection process of 3-way handshake.

Accordingly, thereafter, the client 10A may perform a normal transaction. The client 10A transmits <A, S, #cookie+request> to the NAT apparatus 20.

The packet determining unit 231 of the NAT apparatus 20 determines that the packet received from the client 10A does not correspond to any one of the cookie request packet and the cookie response packet (step S731). As a result, the received packet is provided to the NAT unit 210 to translate the inside IP address (NAT inside IP), ‘A’ into the outside IP address (NAT outside IP), ‘C’ (step S733) and provide the packet of <C, S, #cookie+request> to the server 30.

The server 30 provides <S, C, response> as a response to the received packet to the NAT apparatus 20. The packet determining unit 231 of the NAT apparatus 20 also determines that the received packet is not the cookie request packet or the cookie response packet (step S741) to perform only the NAT operation (step S743). Last, the client 10A receives a packet of <S, A, response>.

A new client having the inside IP address (NAT inside IP) ‘B’, may request the cookie to the server 30 through the same outside IP address (NAT outside IP).

The NAT apparatus 20 and the NAT method according, to the embodiment of the present invention will be described with reference to FIG. 8.

A client 10B having the inside IP address (NAT inside IP) ‘B’, requests the cookie to the server. In this case, the packet may be <B, S, cookie request>.

The NAT apparatus 20 determines that the packet received from the client 10B is the cookie request packet (step S811). The cookie deducing unit 233 searches the outside IP address (NAT outside IP) based on the inside IP address (NAT inside IP) of the received packet.

As described above, the outside IP address (NAT outside IP), ‘C’ may be mapped even to the inside IP address (NAT inside IP), ‘B’ similarly to the inside IP address (NAT inside IP) ‘A’.

The cookie deducing unit 233 searches the cookie for the outside IP address (NAT outside IP), ‘C’ with reference to the connection cookie table table_C. Since the entry of the cookie for the outside IP address (NAT outside IP), ‘C’ exists as shown in Table 2 (step S813), the cookie deducing unit 233 deduces the cookie (step S815) and provides the deduced cookie to the cookie response generating unit 237.

The cookie response generating unit 237 may generate the cookie response that follows a standard supported by the NAT apparatus 20 based on the deduced cookie (step S817) and provides a cookie response of <S, B, #cookie> to the client 10B. As described above, in the NAT apparatus 20, the cookie is immediately provided to the client 10B without the connection process of the 3-way handshake, and as a result, a time for which the client 10B is connected to the server 30 may be reduced.

The client 100 may perform the normal transaction based on the received cookie information. The following process is substantially the same as the normal transaction described with reference to FIG. 7.

When the client 10B transmits a packet of <B, S. #cookie+request> to the NAT apparatus 20, the packet determining unit 231 of the NAT apparatus 20 determines that the received packet is not the cookie request packet or the cookie response packet (step S732) and performs the NAT operation (step S734) to transmit a packet of <C, S, #cookie+request> to the server 30.

The server 30 responds to the packet of the client 10B as <S, C, response>, and the NAT apparatus 20 also determines that the packet received from the server 30 does not correspond to the cookie request packet or the cookie response packet (step S742) and performs the NAT operation (step S744) to provide a packet of <S, B, response> to the client 10B.

The NAT apparatus and the NAT method according to the embodiments of the present invention may perform the cookie proxy function even under an environment in which the inside IP address (NAT inside IP) and the outside IP address (NAT outside IP) do not correspond to each other one to one. As a result, security may be improved and a connection delay time may be reduced.

Although the present invention described as above is not limited by the aforementioned embodiments and the accompanying drawings and it will be apparent to those skilled in the art that various substitutions, modifications, and changes can be made without departing from the technical spirit of the present invention.

What is claimed is:

1. A network address translation (NAT) apparatus with a cookie proxy function, comprising:
a NAT unit configured to translate an address so as for a client and a server to communicate with each other through an outside network by referring to a NAT table that manages an inside IP address, and an outside IP address mapped to the inside IF address; and
a cookie proxy unit configured to provide a cookie to the client by referring to a connection cookie table that manages a cookie corresponding to the outside IP address when the client transmits a cookie request.

2. The NAT apparatus of claim 1, wherein the cookie proxy unit includes:
a packet determining unit configured to determine whether a received packet corresponds to a cookie request packet or a cookie response packet; and
a cookie deducing unit configured to deduce the cookie from the connection cookie table by searching the outside IF address of the received packet from the NAT table when the received packet is the cookie request packet.

3. The NAT apparatus of claim 2, further comprising:
a cookie responding unit configured to generate a cookie response based on the deduced cookie.

4. The NAT apparatus of claim 2, wherein the cookie deducing unit transfers the received packet to the NAT unit when the received packet is the cookie request packet, but an entry corresponding to the outside IP address does not exist in the connection cookie table.

5. The NAT apparatus of claim 4, wherein the NAT unit requests the cookie to the server by performing network address translation (NAT) for the received packet corresponding to the cookie request packet.

6. The NAT apparatus of claim 2, wherein the cookie proxy unit further includes a cookie managing unit configured to update the connection cookie table or generate a new entry based on cookie information included in the received packet when the received packet is the cookie response packet.

7. The NAT apparatus of claim 2, wherein the packet determining unit provides the received packet to the NAT unit, which performs a network address translation operation when the received packet does not correspond to at least one of the cookie request packet and the cookie response packet.

8. The NAT apparatus of claim 2, further comprising:
a client terminal physically connected with a network at the client side and a server terminal physically connected with a network at the server side.

9. The NAT apparatus of claim 8, wherein the packet determining unit determines only whether the received packet is the cookie request packet when the received packet is received from the client terminal and determines only whether the received packet is the cookie response packet when the received packet is received from the server.

10. The NAT apparatus of claim 1, wherein the connection cookie table includes information on a pointer in the NAT table corresponding to the outside IF address of the cookie or an outside port corresponding to the outside IP address.

11. A network address translation (NAT) method supporting a cookie proxy function in a NAT apparatus including a connection cookie table managing a cookie corresponding to an outside IP address, the method comprising:
determining whether a received packet corresponds to a cookie, request packet or a cookie response packet; and
providing a cookie response by deducing a cookie from the connection cookie table when the received packet corresponds to the cookie request packet.

12. The NAT method of claim 11, wherein the providing of the cookie response includes:
searching an outside IP address from a NAT table based on an inside IP address included in the received packet;
deducing the cookie from the connection cookie table based on the searched outside IP address; and
generating the deduced cookie as the cookie response.

13. The NAT method of claim 12, further comprising:
performing network address translation for the received packet when there is no entry of the outside IP address of the received packet in the connection cookie table.

14. The NAT method of claim 11, further comprising;
managing the connection cookie table based on cookie information included in the received packet when the received packet is the cookie response packet.

15. The NAT method of claim 11, further comprising:
performing a network address translation (NAT) operation for the received packet when the received packet does not correspond to at least one of the cookie request packet and the cookie response packet.
